(19) United States
(12) Patent Application Publication
(10) Pub. No.: US 2013/0320885 A1
(43) Pub. Date: Dec. 5, 2013

(54) Audience Participatory Effect System and Method

(71) Applicant: Charles Andrew Griebel, Little Rock, AR (US)

(72) Inventor: Charles Andrew Griebel, Little Rock, AR (US)

(21) Appl. No.: 13/908,846

(22) Filed: Jun. 3, 2013

Related U.S. Application Data
(60) Provisional application No. 61/655,336, filed on Jun. 4, 2012.

(51) Int. Cl. H05B 37/02

(52) U.S. Cl. CPC H05B 37/02
USPC 315/312

(57) ABSTRACT

A system for providing effects during an event includes a control device and multiple audience devices, where each of the audience devices are worn by or otherwise associated with individual members of the audience. Signals from an emitter on the control device control the effects on the audience devices. Lighting effects across an event audience may be achieved by varying the color, intensity, and timing of the activation of the LEDs on the audience devices. The signal from the control device emitter may be directional, such that only certain audience devices produce the desired lighting effect at any given time, and the movement of lighting affects through the audience may be dynamically controlled.

### CROSS-REFERENCE TO RELATED APPLICATIONS

This application claims the benefit of U.S. provisional patent application no. 61/655,336, entitled “Audible and/or Visually Activated Crowd Individual Light Application and Hardware Device,” filed on Jun. 4, 2012. Such application is incorporated herein by reference.

### STATEMENT REGARDING FEDERALLY SPONSORED RESEARCH OR DEVELOPMENT

Not applicable.

### BACKGROUND OF THE INVENTION

Various forms of lighting displays have been used at events where crowds gather, such as sporting events, concerts, and community festivals. Lighting and sound displays at such events are generally created by equipment at or near a stage, or overhead or behind the individual audience members attending such an event. Lighting has long been recognized to bolster a sense of participation for individuals attending the event. For example, team colors may be displayed at sporting events to further the sense of participation and excitement for the team's supporters. Lighting has also been shown to increase the excitement level of individual audience members at various types of other events, such as pop music concerts.

The ubiquity of cellular telephones, and in particular “smart” phones with color output displays, has given rise to their use by individual audience members in order to participate in events by, for example, displaying an image on the smart phone display or activating a light. The control over the lighting display from each individual smart phone is controlled by that phone's user, and thus is only roughly coordinated with the activity of other smart phone users in the audience. Examples include audience members activating a particular image or a light on their smart phones, and then waving their phones above their heads in time to the beat of the music during a concert performance.

Attempts have been made to develop light and/or sound displays that involve the individual members of an audience in a more synchronized manner. The idea behind such systems is to further enhance the sense among audience members that they are connected to the event and to each other as participants in the event rather than simply as passive viewers or listeners. In particular, the art includes attempts to coordinate the output of cellular telephones for various purposes, including attempts to coordinate a light display created by individuals at an event using cellular telephones. For example, by coordinating smart phone displays based on individual audience member location, it may be possible to display a design or message across a stadium crowd using the individuals' cellular telephones. U.S. Pat. No. 7,697,925 to Wilson et al. teaches one such attempt to fulfill this goal.

Because smart phones are not designed specifically for the purpose of providing lighting effects in an audience setting, their use for this purpose involves a number of limitations and disadvantages. The individual audience members must download an application program (“app”) to their phones prior to participation in the event. Some audience members may not have a smart phone, or may have a phone that is incompatible with the available software, and thus would be unable to participate. Furthermore, a synchronizer is required for such systems in order to have the individual audience member displays coordinated as intended by the lighting designer. Activation of various audience members' phone displays is based on position at the event, or proximity to other audience members, and thus dynamic control of lighting effects using this system is quite limited. The inventors hereof have recognized that a system that provides greater freedom of design in various lighting effects that include individual audience member participation would be highly desirable. A system that allowed for dynamic audience participation during the event would also be highly desirable.

References mentioned in this background section are not admitted to be prior art with respect to the present invention.

### BRIEF SUMMARY OF THE INVENTION

The present invention is directed to a system comprising a control device and a plurality of audience devices in communication with the control device in order to control illumination or other activation of the audience devices during an event. By varying the signal sent by the control device and the orientation of the emitter of the control device, many visible, audible, and vibratory effects may be achieved. Lighting effects made possible using various embodiments of the invention may include solid color light displays, flashes, and strobe lighting effects. The lighting effects may be dynamically controlled, if desired, by changing the signal sent by the emitter and the orientation of the emitter.

In a first aspect, the invention is directed to a system for providing lighting effects during an event attended by an audience comprising a plurality of individuals, the system comprising a control device comprising an emitter, and a plurality of audience devices, each of the plurality of audience devices comprising a sensor configured to receive a signal from the control device, and a light source configured to emit light in response to the signal from the control device.

In a second aspect, the invention is directed to a method of providing a light display involving members of an audience attending an event, the method comprising the steps of producing at a DMX controller a DMX signal, receiving at a control device a DMX signal, processing at the control device the DMX signal to produce a digital signal, and receiving at an audience device positioned proximally to an audience member the digital signal and processing the digital signal to produce a light display.

In a third aspect, the invention is directed to an event lighting system for a venue designed to receive an audience, the event lighting system comprising a lighting controller configured to output a lighting signal, a control device in communication with the lighting controller, wherein the control device comprises a broadcast emitter and a control processor configured to receive the lighting signal and produce a broadcast signal, and further wherein the emitter is configured to broadcast the broadcast signal, and a plurality of audience devices each comprising a sensor configured to receive the broadcast signal, an audience processor in communication with the sensor and operable to produce a lighting signal, and a light source configured to produce a lighting effect in response to the lighting signal.

These and other features, objects and advantages of the present invention will become better understood from a consideration of the following detailed description of the preferred embodiments and appended claims in conjunction with the drawings as described following:

### BRIEF DESCRIPTION OF THE SEVERAL VIEWS OF THE DRAWINGS

FIG. 1 is a schematic diagram of a control device according to a preferred embodiment of the present invention.

FIG. 2 is a schematic diagram of an audience device according to a preferred embodiment of the present invention.

FIG. 3 is a schematic diagram showing a typical application of the control device and audience devices in an event venue according to a preferred embodiment of the present invention.

FIG. 4 is a data flow diagram depicting the processing for a control device according to a preferred embodiment of the present invention.

FIG. 5 is a data flow diagram depicting the processing for an audience device according to a preferred embodiment of the present invention.

### DETAILED DESCRIPTION OF THE PREFERRED EMBODIMENT(S)

Before the present invention is described in further detail, it should be understood that the invention is not limited to the particular embodiments described, and that the terms used in describing the particular embodiments are for the purpose of describing those particular embodiments only, and are not intended to be limiting, since the scope of the present invention will be limited only by the claims.

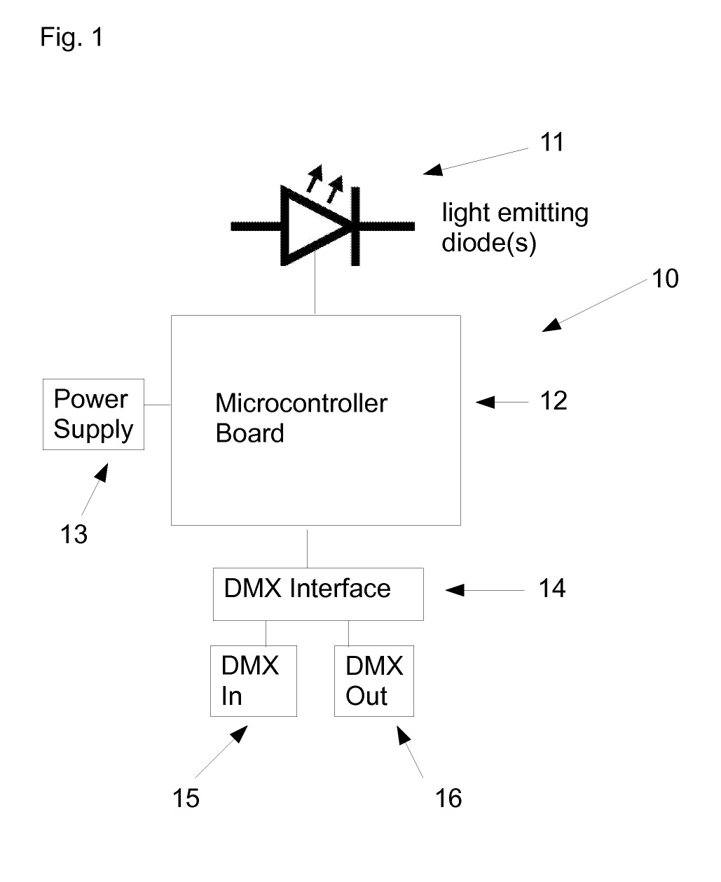

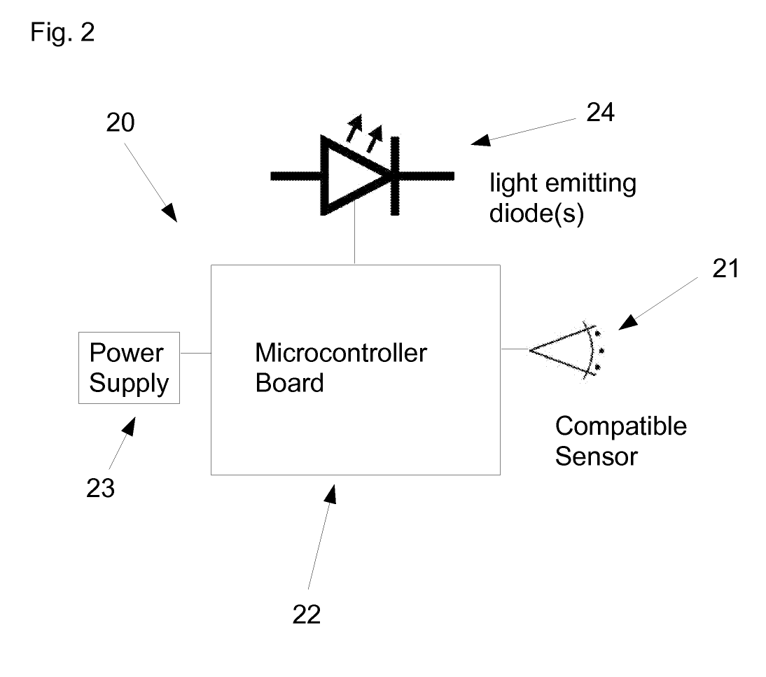

The preferred embodiment of the present invention incorporates a control device 10 and a plurality of audience devices 20, as set forth schematically in FIGS. 1 and 2, respectively. Control device 10 is used to send signals to the plurality of audience devices 20. Control device 10 emits a signal from emitter 11. In the preferred embodiment, pulse-width modulation (PWM) is the format of the signal sent from control emitter 11 to audience devices 20. Use of PWM signals allows control emitter 11 to send a signal to audience device 20 that is an encoded message corresponding to a desired light display. It may be noted that in alternative embodiments of the present invention, various other forms of communication could be used in order for emitter 11 to send signals to audience devices 20, including both digital and analog signals.

In the preferred embodiment, the signal sent at control emitter 11 is sent at a wavelength or wavelengths not visible to the human eye. This allows for communications signals to be sent between control device 10 and audience devices 20 in a way that is entirely transparent to the audience members. The industry standard of 940 nm at 38 KHz, which is within the infrared (IR) spectrum, may be employed in a preferred embodiment of the present invention, although it will be understood that other wavelengths and frequencies may be chosen in alternative embodiments of the present invention.

Referring now specifically to FIG. 1, processing at control device 10 to provide instructions to control emitter 11 and produce the PWM signal is performed at control microcontroller board 12. Numerous processors, microcontrollers, and microprocessors are known in the art that could be used for providing the hardware necessary to process and create signals at emitter 11. Preferably, microcontroller board 12 includes embedded software or firmware designed to provide this functionality. In alternative embodiments, the processing for control device 10 could be implemented solely in hardware, such as with discrete integrated circuits interconnected with each other on a printed circuit (PC) board. Power for control device 10 is provided by power supply 13, which may be connected to an off-board source of electrical current, or (preferably) may include a battery to provide current to operate control device 10.

Lighting control communications with control device 10 take place through DMX interface 14. DMX is the current industry standard protocol for digital communications networks used to control stage lighting and effects, and is thus employed in the preferred embodiment of the present invention. By using the DMX protocol, the preferred embodiment of the present invention may be easily integrated with existing stage and venue lighting systems. As will be understood by those of skill in the art, devices in a DMX network are each associated with a particular DMX channel, allowing control device 10 to receive signals intended only for that control device 10, and also allowing for multiple control devices 10 to be employed as part of a network, as desired in various embodiments and for various lighting displays and effects all within the scope of the present invention. In alternative embodiments, however, any other form of communications protocol could be used in connection with the present invention. DMX input 15 and DMX output 16 are connections that allow DMX signals to be sent to and from control device 10, respectively. These preferably use DMX industry-standard pin configurations, such as XLR-5, XLR-3, or RJ-45, but proprietary or other alternative pinout arrangements could be used in alternative embodiments of the present invention.

The schematic design of audience device 12 according to a preferred embodiment of the present invention is shown in FIG. 2. Sensor 21 of audience device 12 is operable to search for and receive a signal from controller emitter 11 of control device 10. Sensor 21 is chosen to be compatible with the frequency and wavelength specifications of control emitter 11. Sensor 21 is connected to audience microcontroller board 22, which provides processing for audience device 20 in a manner similar to the function of control microcontroller board 12 of control device 10. Specifically, audience microcontroller board 22 receives the PCM signal from sensor 21, and outputs appropriate control signals for lighting. Audience microcontroller board 22 is provided current for operation by audience power supply 23, preferably using batteries of various known sorts, in order that audience device 12 may be easily portable. In alternative embodiments, however, any other form of audience power supply 23 to provide current to audience device 20 may be employed.

Light emitting diodes (LEDs) 24 provide for the lighting effects of audience device 20 according to a preferred embodiment of the present invention. Preferably, LEDs 24 may be of multiple colors, such as including red, green, and blue LEDs 24 in order to allow audience device 20 to produce a full spectrum of possible human-perceptible colors in creating lighting effects. By controlling each of the separate colors and their intensity for a particular display effect through the PCM signal received from control device 10, audience devices 20 may collectively produce a great many desired lighting colors and shapes within the audience.

As an alternative to or in addition to LEDs 24, alternative embodiments of the present invention may use other types of effects that are generated at audience devices 20. Any type of audience-perceptible output may be created at audience devices 20. For example, audience devices 20 could include speakers for the purpose of playing audible sounds, such as music or messages. Also, audience devices 20 could include vibration motors to produce a vibratory effect, or other devices to produce other types of tactile responses perceptible by the audience member.

Various forms of cases for control device 10 and audience devices 20 are within the scope of present invention. Audience devices 20 are preferably constructed to be small and portable, and also to be relatively inexpensive since they will be distributed to audience members at an event. The cases may be created to fit within or form common objects. For example, audience devices 20 may be incorporated into or themselves form such devices as medallions or necklaces, hats and/or caps, lanyards, wristbands, shirts, flying discs such as the Frisbee brand flying discs, balls, balloons, and badges. In alternative embodiments, audience devices 20 may be made to be positioned within an audience either in addition to or in lieu of audience-wearable audience devices 20. Such devices could include large arrays of LEDs 24 for various desired effects.

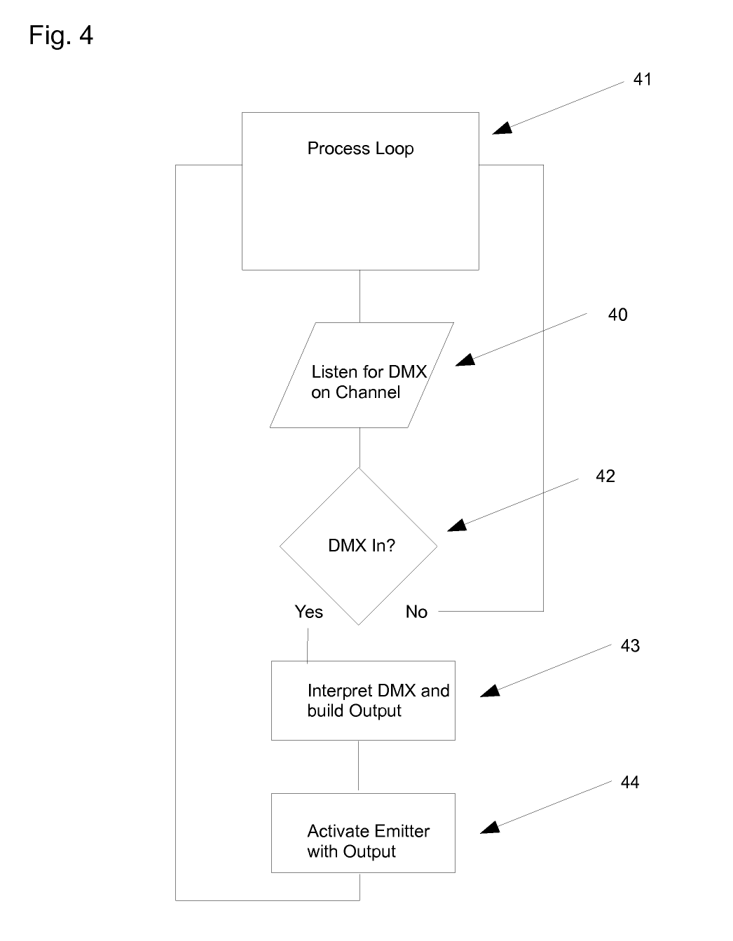

Turning now to FIG. 4, the data flow processing performed at control device 10 may be set forth in greater detail. When control device 10 is powered on, it enters a “wait” mode at block 40 while it looks for a DMX signal at DMX input 15. So long as no input is detected at DMX input 15, processing at control device 10 continues to loop through control process loop block 41. When a signal is detected from DMX input 15 at decision block 42, that signal passes through DMX interface 14 and the interpreted signal is then sent to control microcontroller board 12. Control microcontroller board 12 constructs from this signal an output signal at block 43, and then activates control emitter 11 to produce a PWM signal that is broadcast from control device 10 at block 44. Processing then returns to control process loop 41 while control device 10 awaits the next input at DMX input 15.

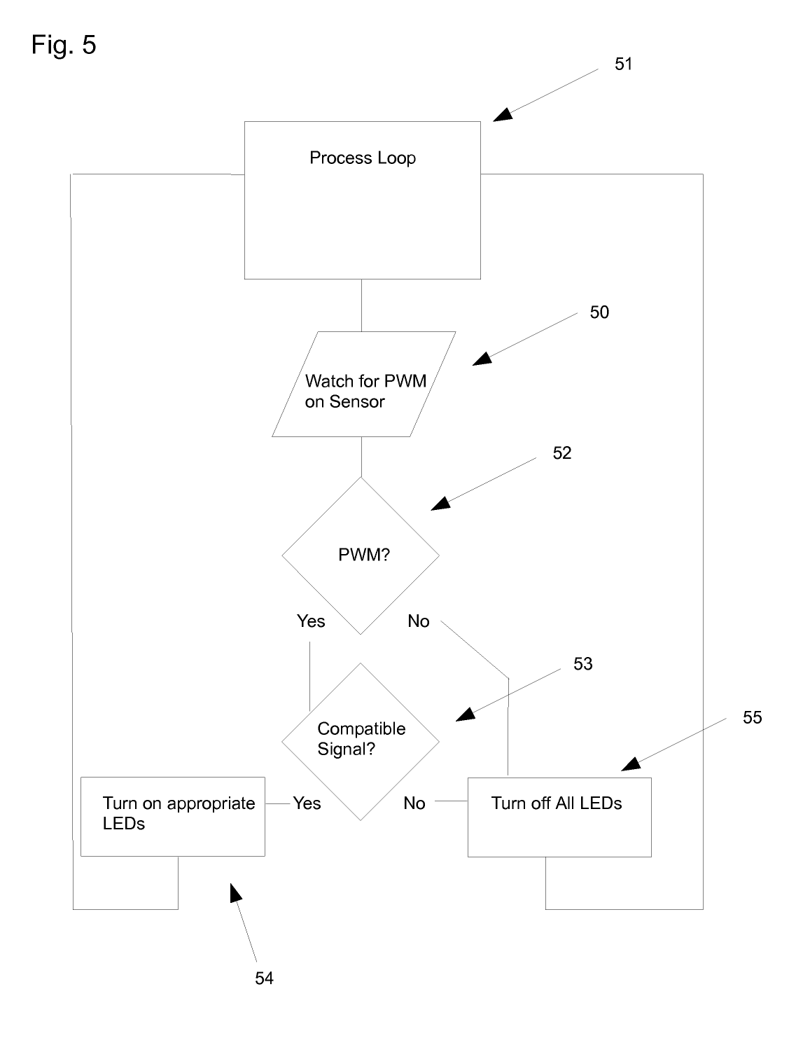

Data flow processing for audience device 20 may now be described with reference to FIG. 5. When audience device 20 is powered on, it enters a “wait” mode at block 50 while it looks for a PWM signal using sensor 21. If no PWM signal is detected at sensor 21, processing at audience device 20 proceeds through PWM decision block 52 to decision block 55, where LEDs 24 are maintained in an “off” position, and the audience device 20 continues to loop back through audience process loop block 51. When a PWM signal is detected from sensor 21 at PWM decision block 52, that signal is then checked to see if it is a signal compatible with audience device 20 at decision block 53. This accounts for the possibility of signals being detected that were not intended for this audience device 20. The PWM signal preferably is of a fixed-bit length with a signature bit or bits, in accordance with the software and/or hardware operating control device 10 and audience device 20. If the signal is found to be incompatible, then processing returns through block 55 to turn off or maintain in the off position LEDs 24, and then back through audience process loop block 51. If the signal is found to be compatible, that is, the PWM signal is of the correct length and includes a proper signature bit or bits, then processing moves to block 54, where the appropriate LEDs 24 are activated as dictated by the PWM signal that was received through processing at audience microcontroller board 22. For example, in the preferred embodiment the PWM signal may indicate which colors of LEDs 24 are powered, and what intensity each of the LEDs are powered at in order to produce any possible color across the visible spectrum at any desired intensity within the operable range. Processing then returns to audience process loop block 51 to await another PWM signal. When the PWM signal is no longer detected at sensor 21, then LEDs 24 are turned off. This could occur because sensor 21 was blocked in some way (such as, for example, an audience member placing a hand over audience device 20 or standing closely behind another audience member), or because the focus beam of emitter 11 has moved away or there is no longer a signal from emitter 11. It should be noted that in preferred embodiments the compatible PWM signal sequences are programmable such that the signals may be changed as needed or desired over time for security and compatibility between various equipment configurations.

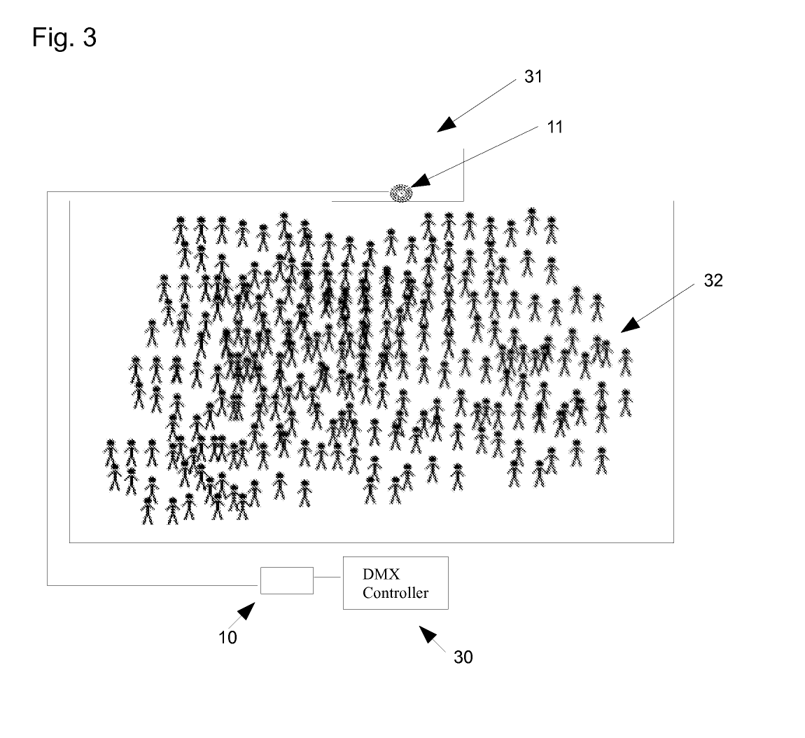

The design and operation of control device 10 and audience device 20 having now been described, the use of these devices in an exemplary venue application may be described with reference to FIG. 3. In this example, an event lighting designer or operator may wish to cause certain audience devices 20 that have been distributed among an audience to turn on their red LEDs among LEDs 24 of each audience device 20. A person acting as the event lighting operator operates DMX controller 30, many such devices being well known in the art for the design and coordination of lighting effects at various sorts of events. Often the lighting operator is positioned on a raised platform in an audience or behind an audience, as shown in FIG. 3, but this arrangement could vary in alternative embodiments of the invention. In response to lighting operator commands, DMX controller 30 sends a DMX-formatted signal to DMX input 15 at control device 10, indicating that red LEDs 24 should be turned on. In this example according to a preferred embodiment, emitter 11 is positioned at or near stage 31, and thus emitter 11 of control device 10 is pointed towards a forward-facing audience, at least some of the members of which have an audience device 20. The precise direction in which emitter 11 is pointed may allow its signal to only reach certain audience devices 20, depending upon the width of the beam produced by emitter 11 in various embodiments. By changing the orientation of emitter 11, different audience devices 20 may thus be reached. In any event, in response to a PWM signal from emitter 11, the red LEDs 24 of one or more audience devices 20 light in accordance with the instructions encoded into the PWM signal from control device 10. Once the audience devices 20 no longer detect the PWM signal at sensor 21 indicating that the red LEDs 24 should be on, the audience devices 20 will switch the LEDs 24 to an off position until another PWM signal is received from emitter 11 of control device 10.

Using the preferred embodiment of the present invention as set forth herein, a great variety of lighting effects may be achieved by varying the type of signal and timing of the signal sent from DMX controller 30, as well as the placement, orientation, and movement of emitter 11. For example, effects that could be created include pans, focus rings (i.e., spotlights), floods, animation and video renderings (achieved through fast scanning with tightly focused multiple emitters 11), strobe effects, and flash effects. The quantity, size, and intensity of the one or more emitters 11 may vary based upon the desired effects and venue size. To provide additional control, emitter 11 signals may be further directionally refined with standard lighting techniques such as moving heads, “go betweens” (GOBOs) to produce shaped control effects, and spot/flood focus adjustments. It should further be understood that while some of the examples given herein incorporate only one control device 10 communicating with multiple audience devices 20, multiple control devices 10 and/or multiple emitters 11 forming part of a control device 10 could also be used in various embodiments for more complex lighting effects. In addition, the focus pattern (coverage area) of emitters 11 of control devices 10 may be statically or dynamically varied in order to produce various lighting effects.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

All terms used herein should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. When a Markush group or other grouping is used herein, all individual members of the group and all combinations and subcombinations possible of the group are intended to be individually included in the disclosure. All references cited herein are hereby incorporated by reference to the extent that there is no inconsistency with the disclosure of this specification.

1. A system for producing effects during an event attended by an audience comprising a plurality of individuals, the system comprising:
a. a control device comprising an emitter; and
b. a plurality of audience devices, each of the plurality of audience devices associated with one of the individuals in the audience, wherein each of the audience devices comprises a sensor configured to receive a signal from the control device, and an effect source configured to emit an effect in response to the signal from the control device;
wherein the effect emitted by at least one of the audience devices is coordinated with the effect emitted by at least one other of the audience devices.

2. The system of claim 1, wherein the effect source is a lighting source and is configured to produce a lighting effect.

3. The system of claim 2, wherein the emitter comprises a pulse-width modulated (PWM) signal emitter.

4. The system of claim 3, wherein at least one of the sensors of the plurality of audience devices comprises a PWM signal sensor.

5. The system of claim 4, wherein the light source comprises at least one light-emitting diode (LED).

6. The system of claim 5, wherein the light source comprises a plurality of LEDs, wherein at least one of the LEDs is configured to emit a first color and at least one other of the LEDs is configured to emit a second color different from the first color.

7. The system of claim 6, wherein the light source comprises an LED configured to emit red light, an LED configured to emit green light, and an LED configured to emit blue light.

8. The system of claim 7, wherein the control device further comprises a processor and a DMX interface, wherein the DMX interface is configured to receive a DMX command and send a corresponding signal to the processor, and the processor is configured to send an emitter signal to the emitter of the control device.

9. The system of claim 8, wherein the control device further comprises a DMX input in communication with the DMX interface, and the system further comprising a DMX controller in communication with the DMX input of the control device.

10. The system of claim 5, wherein the PWM signal emitter is configured to produce a directional PWM signal.

11. The system of claim 10, wherein the emitter is configured to change orientation whereby the directional PWM signal changes from a direction PWM signal oriented in a first direction to a directional PWM signal oriented in a second direction different from the first direction.

12. A method of providing an effect involving members of an audience attending an event, the method comprising the steps of:
a. producing at a DMX controller a first DMX signal;
b. receiving at a control device the first DMX signal;
c. processing at the control device the first DMX signal to produce by means of an emitter at the control device a first digital control signal;
d. receiving at a first plurality of audience devices each positioned proximally to an associated audience member the first digital control signal; and
e. processing the first digital control signal at the first plurality of audience devices to produce a first effect at each of the first plurality of audience devices, wherein the first effect produced at one of the first plurality of audience devices is coordinated with the first effect produced at one other of the first plurality of audience devices.

13. The method of claim 12, wherein the first plurality of audience devices each comprise a color light display, and the first digital control signal comprises color information, whereby the color light display produces a color of light corresponding to the first digital control signal color information.

14. The method of claim 13, further comprising the steps of:
a. moving the emitter from pointing in a first direction to pointing in a second direction, wherein the second direction is different from the first direction;
b. producing at the DMX controller a second DMX signal;
c. receiving at the control device the second DMX signal;
d. processing at the control device the second DMX signal to produce from the emitter a second digital control signal;
e. receiving at a second plurality of audience devices the second digital control signal, wherein at least one of the first plurality of audience devices is not within the second plurality of audience devices, or at least one of the second plurality of audience devices is not within the first plurality of audience devices; and
f. processing the second digital control signal at the second plurality of audience devices to produce a second effect at each of the second plurality of audience devices, wherein the second effect produced at one of the second plurality of audience devices is coordinated with the second effect at one other of the second plurality of audience devices.

15. An event lighting system for a venue designed to receive an audience, the event lighting system comprising:
a. a lighting controller configured to output a controller signal;
b. at least one control device in communication with the lighting controller, wherein the at least one control device comprises an emitter and a control processor configured to receive the controller signal and produce a directional broadcast signal; and
c. a plurality of audience devices each comprising a sensor configured to receive the directional broadcast signal, an audience processor in communication with the sensor and operable to produce a lighting signal, and a light source configured to produce a lighting effect in response to the lighting signal.

16. The event lighting system of claim 15, wherein the emitter of the at least one control device is positioned in front of and oriented in a direction generally towards the audience.

17. The event lighting system of claim 16, wherein the emitter is configured to produce the broadcast signal directionally.

18. The event lighting system of claim 17, wherein the emitter is configured to be dynamically repositioned from a first direction to a second direction, whereby a first subset of the plurality of audience devices receives the broadcast signal at a first time and a second subset of the plurality of audience devices receives the broadcast signal at a second time, wherein at least one of the audience devices present in the first subset of audience devices is not present in the second subset of audience devices, or at least one of the audience devices present in the second subset of audience devices is not present in the first subset of audience devices.
